(19) United States
(12) Patent Application Publication
(10) Pub. No.: US 2003/0009654 A1
(43) Pub. Date: Jan. 9, 2003

(54) Computer system having a single processor equipped to serve as multiple logical processors for pre-boot software to execute pre-boot tasks in parallel

(76) Inventors: Rajeev K. Nalawadi, Folsom, CA (US); Faraz A. Siddioi, Folsom, CA (US); Steven P. Mooney, Folsom, CA (US)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/893,718

(22) Filed: Jun. 29, 2001

(51) Int. Cl. G06F 15/177; G06F 9/24

(52) U.S. Cl. 713/1; 713/2

(57) ABSTRACT

A computer system is provided with a single processor equipped to serve as multiple logical processors. The computer system comprises a host chipset connected to the processor; PCI devices connected to the host chipset, via a PCI bus; and a main storage connected to the host chipset and arranged to store an operating system (OS) and contain a basic input/output system (system BIOS) configured to execute multiple pre-boot tasks, including memory initialization and PCI bus initialization concurrently, on the processor which serve as multiple logical processors before passing control to the operating system (OS).

### TECHNICAL FIELD

The present invention relates to computer systems, and more particularly, relates to a computer system having a single processor equipped to serve as multiple logical processors for a pre-boot software such as a basic input/output system (BIOS) to execute multiple pre-boot tasks in parallel for faster and better performance.

### BACKGROUND

Computer systems such as personal computers (PCs) are designed to support one or input/output (I/O) devices, including, for example, keyboards and cursor control devices such as mice, track balls, touch pads and joysticks; storage devices such as magnetic tapes, hard disk drives (HDDs), floppy disk drives (FDDs), compact disk read-only-memory (CD-ROM) devices, readable and writeable compact disks (CDRWs), digital audio tape (DAT) readers, and memory sticks; and serial and parallel ports to peripheral devices such as printers, scanners, and display devices (e.g., cathode ray tube “CRT” monitors, liquid crystal display “LCD” monitors, and flat panel display “FPD” monitors).

One of the critical elements in such computer systems is a pre-boot (automatic start program) software, widely known as a system BIOS, used to set-up proper connections, device configurations and operations of I/O devices. The system BIOS is essentially the machine instruction code typically stored in some form of non-volatile memory to allow a central processing unit (CPU) to perform pre-boot tasks such as clearing memory, initialization, executing diagnostics, loading an operating system (OS) kernel into memory from mass storage, and executing I/O functions and other routines that prepare the computer system for use. These functional tasks of the system BIOS are performed in sequence by the computer system, every time the computer system is turned on (boot up), via a power-up sequence, widely known as Power-On Self Test (POST), until control is passed to the operating system (OS).

However, as computer systems become more powerful and sophisticated, and more powerful peripheral devices with expanded functionality become available, the system BIOS has become much larger. Hence, the serial execution of BIOS functional tasks such as initialization, diagnostics, loading an operating system (OS) kernel into memory from mass storage, and routine I/O functions has become more time consuming. When the CPU is utilized for the pre-boot tasks such as memory initialization, for example, the CPU is not usable for other pre-boot tasks such as PCI bus initialization until the memory initialization task is completed.

One recent solution to enhance the system BIOS performance and increase the operating speed of the system BIOS is to employ multiple physical processors (CPUs) in a multi-processor computer system for sharing the functional tasks of the system BIOS. However, two or more processors (CPUs) such as Intel® i386, i486, Celeron™ or Pentium® processors must be arranged to share the pre-boot functional tasks of the system BIOS. The use of multiple processors (CPUs) to save execution time of the system BIOS is, however, unrealistic and impractical.

Another emerging solution recently developed by Intel Corporation is the Intel® Pentium® Family of Processors each designed to serve as multiprocessor (MP) capable processors (i.e., multiple logical processors). Each Intel® Pentium® 4 Processor is equipped with a new mode of operation (in addition to real and protected modes), known as Jackson technology (JT) which causes a single physical processor from a software perspective (system BIOS) to appear as multiple logical processors, and allow the pre-boot software (system BIOS) to execute two or more different coordinated tasks on a single physical processor which appears as multiple logical processors.

The availability of Jackson Technology (JT) in emerging Intel® Pentium® 4 Family of Processors has provided the opportunity for the pre-boot software (system BIOS) to execute one particular device initialization on one of the logical processors while allowing the other logical processor to proceed with other hardware initialization tasks in order to allow the control to be passed from the pre-boot software (system BIOS) to the operating system (OS) much faster than previously possible. Therefore, there is a need for a new pre-boot software (system BIOS) that can leverage the Jackson Technology (JT) to accomplish all required pre-boot functional tasks more efficiently and quickly in a computer system.

### BRIEF DESCRIPTION OF THE DRAWINGS

A more complete appreciation of exemplary embodiments of the present invention, and many of the attendant advantages of the present invention, will become readily apparent as the same becomes better understood by reference to the following detailed description when considered in conjunction with the accompanying drawings in which like reference symbols indicate the same or similar components, wherein:

FIG. 1 illustrates an example system platform of a typical computer system according to an embodiment of the present invention;

FIG. 2 illustrates an example boot up process of an example system BIOS of the computer system shown in FIG. 1;

FIG. 3 illustrates an example PCI bus initialization process of an example system BIOS of the computer system shown in FIG. 1;

FIG. 4 illustrates an example system platform of a computer system having a single processor equipped with Jackson Technology (JT) to serve as multiple logical processors according to an embodiment of the present invention;

FIG. 5 illustrates an example boot-up process of an example system BIOS of the computer system having a single processor equipped with Jackson Technology (JT) to serve as multiple logical processors according to an embodiment of the present invention; and

FIG. 6 illustrates an example memory initialization process of an example system BIOS of the computer system having a single processor equipped with Jackson Technology (JT) to serve as multiple logical processors according to an embodiment of the present invention.

### DETAILED DESCRIPTION

The present invention is applicable for use with all types of computer systems including Intel® Pentium® 4 Family of Processors or any new processors or chipsets designed to serve as multiprocessor (MP) capable processors (multiple logical processors) which may become available as computer technology develops in the future. Such computer systems may include, but not limited to, general purpose computer systems (e.g., servers, laptop computers, desktop computers, palmtop devices, personal electronic devices, etc.), personal computers (PCs), hard copy equipments (e.g., printers, plotters, fax machines, etc.), banking equipments (e.g., automated teller machines) and the like. However, for the sake of simplicity, discussions will concentrate mainly on a typical computer system containing one of Intel® Pentium® 4 Family of Processors designed to serve as multiple logical processors, although the scope of the present invention is not limited thereto.

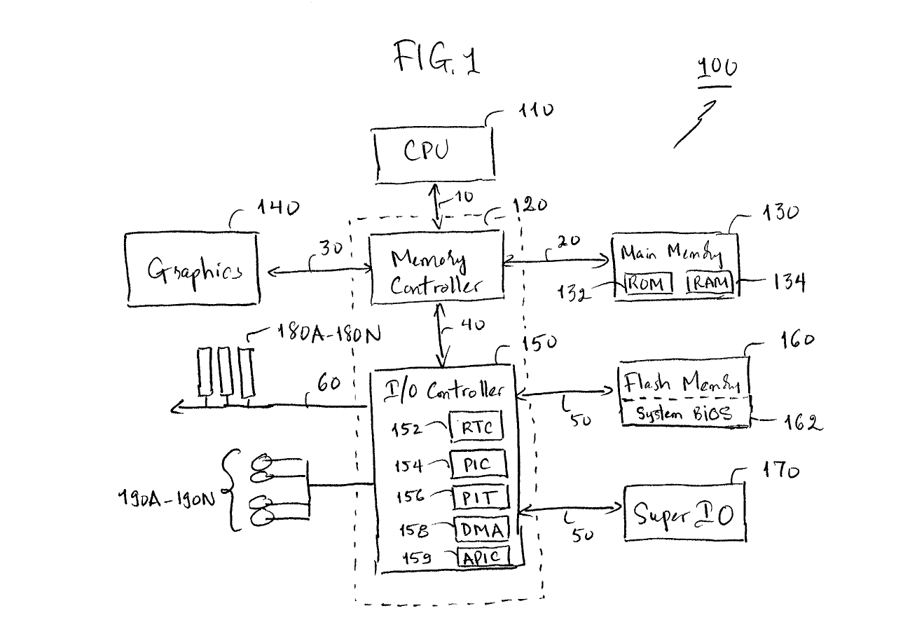

Attention now is directed to the drawings and particularly to FIG. 1, an example system platform of a typical computer system is illustrated. As shown in FIG. 1, the computer system 100 may include a processor (CPU) 110; a memory controller hub (MCH) 120 connected to the processor (CPU) 110, via a front side bus 10; a main memory 130 connected to the memory controller hub (MCH) 120, via a memory bus 20; a graphics/display subsystem 130 connected to the memory controller hub (MCH) 120, via a graphics bus 30; an I/O controller hub (ICH) 150 connected to the memory controller hub (MCH) 120, via a hub link 40; a flash memory 160 and a super I/O 170 connected to the I/O controller hub (ICH) 150, via a low pin count (LPC) bus 50; expansion (PCI) slots 180 connected to the I/O controller hub (ICH) 150, via a peripheral bus such as a Peripheral Component Interconnect (PCI) bus 60 (PCI Local Bus Specification Revision 2.2 as set forth by the PCI Special Interest Group (SIG) on Dec. 18, 1998); and a plurality of Universal Serial Bus (USB) ports (USB Specification, Revision 2.0 as set forth by the USB Special Interest Group (SIG) on Apr. 27, 2000) and Ultra/66 AT Attachment (ATA) 2 ports (X3T9.2 948D specification; commonly also known as Integrated Drive Electronics (IDE) ports) 190A-190N connected to the I/O controller hub (ICH) 150.

The processor (CPU) 110 may include an Arithmetic Logic Unit (ALU) for performing computations, a collection of registers for temporary storage of data and instructions, and a control unit for controlling operation for the computer system 100. The processor (CPU) 110 may include any one of Intel® i386, i486, Celeron™ or Pentium® processors as marketed by Intel® Corporation, K-6 microprocessors as marketed by AMD™, 6x86MX microprocessors as marketed by Cyrix™ Corporation, Alpha™ processors as marketed by Digital Equipment Corporation™, 680x0 processors as marketed by IBM™.

The main memory 130 may correspond to a dynamic random-access-memory (DRAM), but may be substituted for read-only-memory (ROM), video random-access-memory (VRAM), synchronous dynamic random-access-memory (SDRAM) and the like. Such a memory 130 may include a non-volatile memory 132 such as a read-only-memory (ROM) which stores an operating system (OS) for use by the processor (CPU) 110, and a volatile memory 134 such as a random-access-memory (RAM), a static dynamic random-access-memory (SDRAM) or other memory devices such as RAMBUS DRAM which stores temporary information for use by the processor (CPU) 110. The operating system (OS) may include any type of OS, including, but not limited to, Disk Operating System (DOS), Windows™ (e.g., Window™ 95/98, Window™ NT, and Window™ 2000), Unix, Linux, OS/2, OS/9 and Xenix, for use by the processor (CPU) 110.

The graphics/display subsystem 140 may include, for example, a graphics controller, a local memory and a display monitor (e.g., cathode ray tube “CRT” monitor, liquid crystal display “LCD” monitor, and flat panel display “FPD” monitor).

The flash memory 160 (e.g., ROM and EEPROM) may contain a set of system basic input/output start-up instructions (system BIOS) as well as other applications that may execute during boot up (start-up) before the operating system (OS) is loaded, including power saving instructions for full-on, standby and sleep states in accordance with the Advanced Power Management (APM) specification jointly developed by Intel Corp. and Microsoft Corp. in February 1996, and/or the Advanced Configuration and Power Interface (ACPI) specification, version 1.0B, jointly developed by Intel Corp., Microsoft Corp. and Toshiba Corp. in February 1999. The system BIOS 162 that is encoded in the flash memory 160 also includes runtime code (initialization, configuration and parameter) code tables (not shown) which contain all configuration information necessary to configure a variety of I/O devices connected to the computer system 100 and an ACPI table (not shown) which contains ACPI entries necessary to configure power saving instructions. Alternatively, the system BIOS and ACPI power saving instructions may also be encoded in the non-volatile memory (ROM) 132 of the main memory 130 along with the operating system (OS).

The super I/O 170 may provide the I/O controller hub (ICH) 150 an interface with a variety of I/O devices such as, for example, a keyboard controller for controlling operations of an alphanumeric keyboard, a cursor control device such as a mouse, track ball, touch pad, joystick, etc., a mass storage device such as a magnetic tapes, a hard disk drive (HDD), a floppy disk drive (FDD), a memory stick and serial and parallel ports to printers, scanners, and display devices.

The PCI slots 180 may provide the I/O controller hub (ICH) 150 an interface with a variety of PCI compliant devices (up to 255 PCI devices) such as audio coder/decoder devices (Codec), Codec modems, network interface cards “NIC”, SCSI devices, answering machines, scanners, personal digital assistants and the like, via the PCI bus 60. An Industry Standard Architecture (ISA) or Extended Industry Standard Architecture (EISA) bus option, and a local area network (LAN) option may also be provided.

The USB ports and IDE ports 190A-190N may also be used to provide the I/O controller hub (ICH) 150 an interface to one or more storage devices such as, for example, a hard disk drive (HDD), a compact disk read-only-memory (CD-ROM), a readable and writeable compact disk (CDRW), a digital audio tape (DAT) reader.

The I/O controller hub (ICH) 150 may contain one or more PCI-to-PCI (P2P) bridges or PCI-to-ISA bridges, for example, PIIX4® chips and PIIX6® chips manufactured by Intel Corporation. Such an I/O controller hub (ICH) 150 may also include, but not limited to, a Real Time Clock (RTC) 152, a Programmable Interrupt Controller (PIC) 154 such as the 8259 PIC manufactured by Intel Corporation for single processor implementations, a Programmable Interval Timer (PIT) 156, a Direct Memory Access (DMA) 158, and/or an I/O Advanced Programmable Interrupt Controller (APIC) 159 such as the 82489 DX APIC as described in a publication entitled “82489DX Advanced Programmable Interrupt Controller” published by Intel Corp., and the “MultiProcessor Specification (MPS)” Version 1.1., September 1994, Order Number 242016-003 from Intel Corp.

The memory controller hub (MCH) 120 and the I/O controller hub (ICH) 150 may be implemented along with a firmware hub “FWH” (not shown) on a single host chipset, for example, in Intel® 810, Intel® 870 and 8XX series chipsets. Graphics/display subsystem 140 may even be incorporated into the memory controller hub (MCH) 120 for enhanced functionality.

When the power is applied to the computer system 100 (or during certain resume sequences), the pre-boot software such as a system BIOS 162 that is encoded in the flash memory 160 is always executed first (boot up) to perform several time consuming tasks in sequence such as memory detection and initialization, PCU bus initialization, storage devices detection and initialization (e.g., IDE hard disks, SCSI, network interface cards etc.).

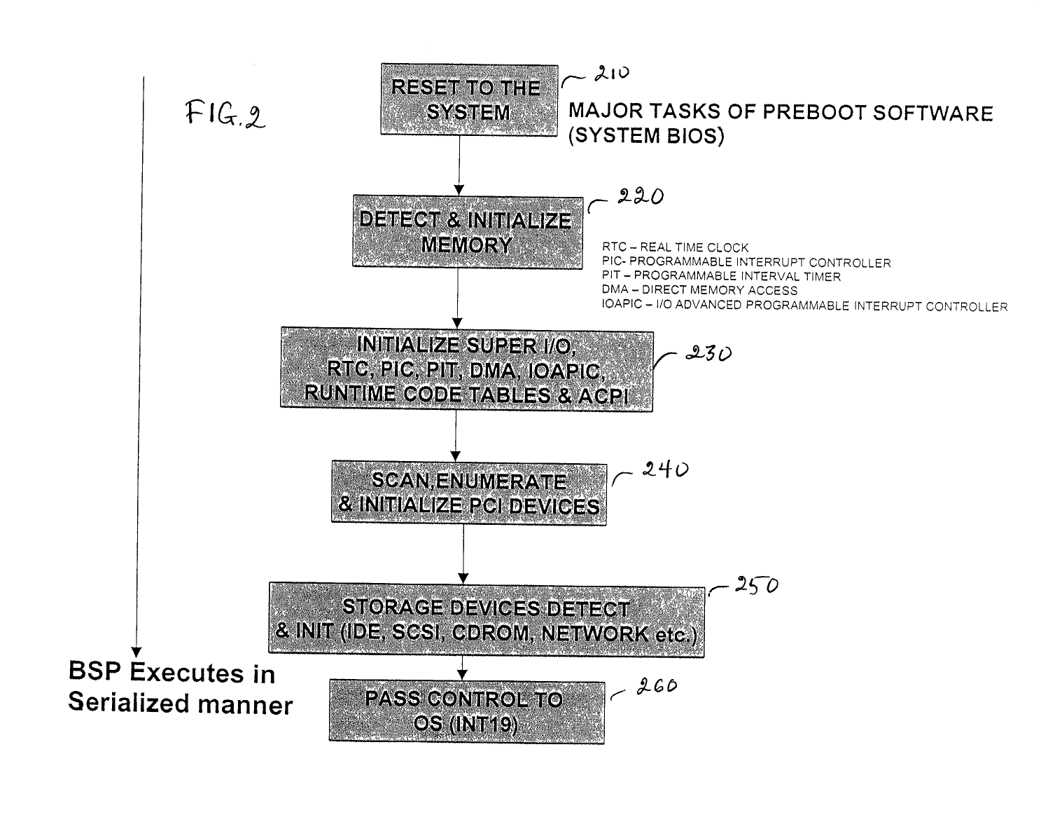

FIG. 2 illustrates an example boot up process of an example system BIOS of the computer system 100. As shown in FIG. 2, following power-up or hard reset, the processor (CPU) 110 begins the power-on self-test (POST) by executing the pre-boot software (system BIOS) 162 stored in the flash memory 160 at block 210.

Initially, the processor (CPU) 110 enables access to the RAM 132 and initializes the entire contents (memory cells) of the memory array of the RAM 132 to zeros “0s” as part of preparing memory that is capable of Error Checking and Correction (ECC) for normal operation at block 220. Typically, the task of ECC memory initialization is executed by using the dword general purpose register format or the MMX™ register format which involves writing a dword (32 bits, general purpose register) or 2 quads (128 bits, MMX) of memory location at a time. As a result, the ECC memory initialization task can be time consuming. The processor (CPU) 110 is completely occupied until the completion of the ECC memory initialization process. The processor (CPU) 110 cannot proceed to other pre-boot tasks before completion of ECC memory initialization process.

Next, the processor (CPU) 110 initializes the super I/O 170, all the internal hardware of the I/O controller hub (ICH) 150 such as the Real Time Clock (RTC) 152, the Programmable Interrupt Controller (PIC) 154, the Programmable Interval Timer (PIT) 156, the Direct Memory Access (DMA) 158, and the I/O Advanced Programmable Interrupt Controller (APIC) 159, the runtime code tables and the ACPI table at block 230.

The processor (CPU) 110 must then accomplish the pre-boot task of PCI bus initialization at block 240. PCI Bus initialization involves 1) scanning the PCI Bus 60 (find Boot capable devices, PCI-to-PCI bridges etc.); 2) enumerate the PCI bus 60 (find devices behind PCI-to-PCI bridges for eg: how many PCI buses are present); and 3) initialize all PCI devices connected to the PCI bus 60 (assign base addresses and enable decoding).

The processor (CPU) 110 then detects and initializes all storage devices (such as IDE hard disks, SCSI devices, CD-ROMs, NICs etc.) at block 250 before the control is passed to the operating system (OS) at block 260. All pre-boot tasks of the system BIOS 162 that is encoded in the flash memory 160 are executed by the processor (CPU) 110 in a serialized manner. As a result, the boot-up process may be slow.

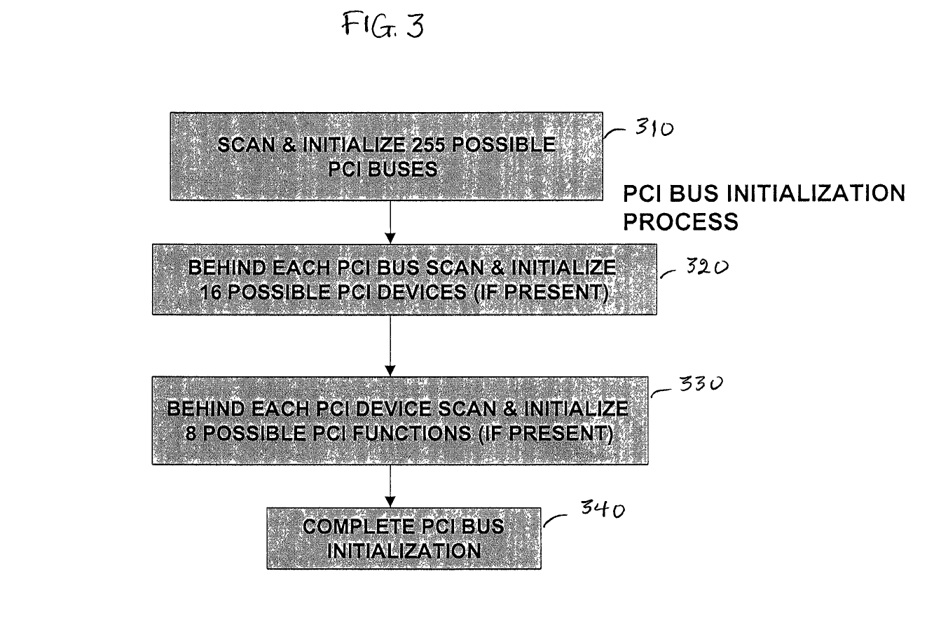

FIG. 3 illustrates a more detailed PCI bus initialization process of a system BIOS that is encoded in the flash memory 140. For example, the processor (CPU) 110 may scan and initialize all 255 possible PCI buses that may be connected to the I/O controller hub (ICH) 150 at block 310. After each PCI bus is scanned, the processor (CPU) 110 may scan and initialize up to 16 possible PCI devices (if present) connected thereto on an individual basis at block 320. Also, after each PCI device is scanned, the processor (CPU) 110 may initialize up to 8 possible PCI functions (if present) assigned thereto on an individual function basis at block 330. Until all the PCI buses, all the PCI devices connected to each PCI bus, and all PCI functions assigned to each PCI device are scanned and initialized, may the task for PCI bus initialization be terminated at block 340.

All specific PCI bus related operations of the system BIOS 162 that is encoded in the flash memory 160 are executed by the processor (CPU) 110 in a serialized manner. In the case of a single processor (CPU) 110 in the computer system 100 as shown in FIG. 1, the processor (CPU) 110 must be completely occupied until the completion of the entire task. The processor (CPU) 110 cannot proceed to other pre-boot tasks before completion of PCI bus initialization. Therefore, the execution of all pre-boot tasks of the system BIOS 162 that is encoded in the flash memory 160 has become time consuming.

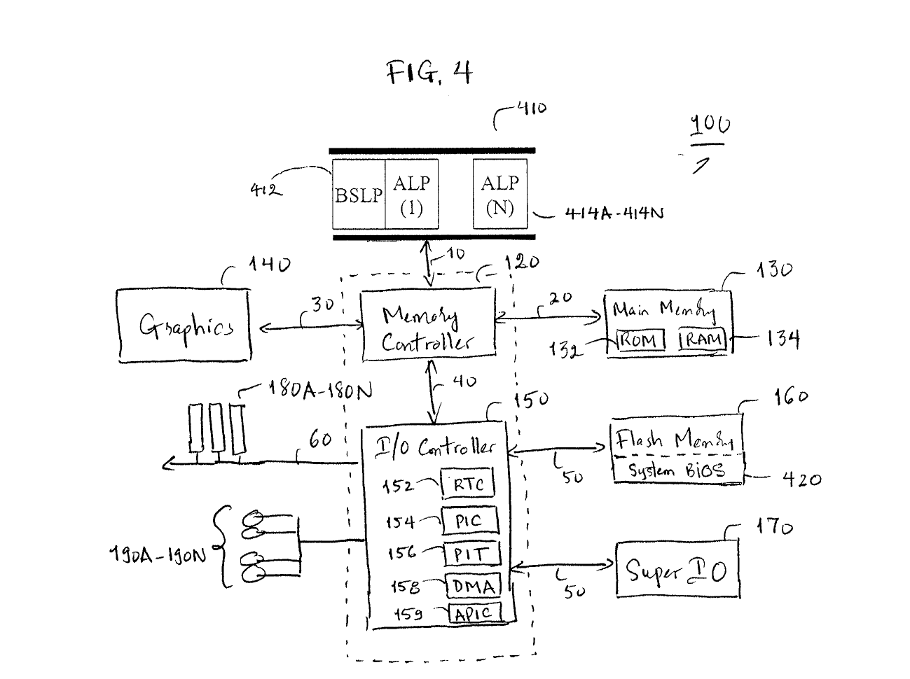

Turning now to FIG. 4, an example computer system platform of a computer system 100 having a single processor (CPU) 410 equipped with Jackson Technology (JT) to serve as multiple logical processors according to an embodiment of the present invention is illustrated. The processor (CPU) 410 may correspond to any one of Intel® Pentium® 4 Family of Processors designed to serve as multi-processor (MP) capable processors (i.e., a single Boot-Strap Logical Processor “BSLP” 412 and one or more Alternate Logical Processors (Application Processors) 414A-414N where N≧1). Each Intel® Pentium® 4 Processor is equipped with a new mode of operation (in addition to real and protected modes), known as Jackson technology (JT) which causes a single physical processor from a pre-boot software (system BIOS 420) to appear as multiple logical processors, and allow the pre-boot software (system BIOS 420) to execute two or more different coordinated tasks on a single physical processor which appears as multiple logical processors.

According to the Intel® Pentium®4 Family of Processors Specification, the processor (CPU) 410 has a set of configuration registers including general purpose registers (EAX, EBX, ECX and EDX registers) and Model Specific Registers (MSR) that is accessible and programmable by the system BIOS stored in the flash memory 140 as described in the Intel Architecture Software Developer's Manual, Volume 2: Instruction Set Reference (243190) and Intel Architecture Software Developer's Manual, Volume 3: System Programming Guide (243192). CPUID instruction may be used by the system BIOS 420 stored in the flash memory 160 to provide the brand identification of the processor (e.g., Family, Model and Stepping) as described in Application Note AP-485 Intel Processor Identification and the CPUID Instruction (Order Number 241618).

When the general purpose register EAX is initialized to a value of “1”, the CPUID instruction may return the Family, Model, and Stepping value in the EAX register as described in the TABLE #1 (CPUID Feature Information) as follows:

TABLE #1
CPUID Feature Information

| Register Bits | Description |
|---|---|
| EAX [31:14] | Reserved |
| EAX [13:12] | Processor Type = 00b |
| EAX [11:8] | Family = 1111b |
| EAX [7:4] | Model = xxxxb |
| EAX [3:0] | Stepping = xxxxb |
| EBX [31:24] | Default APIC ID |
| EBX [23:16] | Logical processor count |
| EBX [15:8] | CLFLUSH chunk count |
| EBX [7:0] | Brand ID |
| ECX [31:0] | Reserved |
| EDX [31:0] | Feature Flags |

The brand ID is returned in general purpose register EBX[7:0] as described in the TABLE #2 (CPUID Family and Model Extensions) as follows:

TABLE #2
CPUID Family and Model Extensions

| Register Bits | Description |
|---|---|
| EAX [31:28] | Reserved |
| EAX [27:20] | Extended Family |
| EAX [19:16] | Extended Model |
| EAX [15:14] | Reserved |
| EAX [13:12] | Processor Type = 00b |
| EAX [11:8] | Family = 1111b |
| EAX [7:4] | Model = xxxxb |
| EAX [3:0] | Stepping = xxxxb |

The value returned in register EBX[23:16] from TABLE #1 reflects the correct number of logical processors 412 and 414A-414N. For the processors that do not support Jackson Technology (JT), the register value will be a “1” indicating that there is only a single processor defined. In the case of the Jackson Technology (JT) enabled processors, the value in the register EBX[23:16] will reflect the correct number of logical processors found within the single physical processor package 410.

The value returned in register EBX[31:24] from TABLE #1 reflects the initially assigned APIC ID which is assigned by the hardware when the processor comes out of RESET#.

The value returned in register EBX[15:8] from TABLE #1 reflects the number of 8-byte chunks evicted from the cache by the CLFLUSH instruction.

The value returned in register EDX[31:0] from TABLE #1 reflects the feature flags. For example, bit #28 pertaining to Jackson Technology (JT) of register EDX may be set to a “1” indicating that the processor has the capability to operate as multiple logical processors within the single physical processor package.

Since each of Intel® Pentium® 4 Family of Processors is equipped to serve as multiple logical processors (i.e., a single Boot-Strap Logical Processor “BSLP” 412 and one or more Alternate Logical Processors (Application Processors) 414 B-414N where N≧1 shown in FIG. 4), the pre-boot software (system BIOS) that is encoded in the flash memory 140 can be configured to execute multiple coordinated tasks on a single physical processor (CPU) 410 which appears as multiple logical processors in order to save pre-boot time and result in faster and better performance. For example, the pre-boot software (system BIOS) 420 that is encoded in the flash memory 160 can be configured to execute one particular pre-boot task such as PCI bus initialization on one of the logical processors while allowing the other logical processor to proceed with other normal hardware initialization tasks (for eg: PIC, Timer, DMA, Programming User SETUP Options) in order to allow the control to be passed from the pre-boot software (system BIOS) to the operating system (OS) much faster than previously possible.

According to an embodiment of the present invention, the system BIOS 420 that is encoded in the flash memory 160 may be configured in conjunction with the processor (CPU) 410 to perform the pre-boot tasks of ECC memory initialization and PCI bus initialization in parallel in the computer system 100 as follows:

ECC Memory Initialization:

1. Execute the CPUID instruction with an argument of “1” in register EAX. The data will be returned by the processor (CPU) 410 as indicated in TABLE #1.

2. Check if bit#28 (Jackson Technology) of register EDX is set to a “1”.

3. Register EBX[23:16] provides the logical processor count. This value has to be a minimum of “2” to support two logical processors. If the value is 2 or more continue with step#4.

4. Processor (CPU) 410 currently executing the code is called as “Boot Strap Logical Processor” hereafter referred to as “BSLP” 412. The other logical processor is called as “Application Logical Processor” hereafter referred to as “ALP” 414A-414 N.

5. BSLP 412 executes the basic memory detection and initialization code so that memory is available.

6. BSLP 412 wakes up the ALP by sending a SIPI (Startup Inter-Processor Interrupt) in case the ALP 414A-414N has not been waken up earlier than memory initialization.

7. BSLP 412 meanwhile executes the ECC memory initialization of the lower 2 Meg of memory so that the BSLP 412 can continue with its task and waits on a memory semaphore (sem#1) indication from ALP 414A-414N that it has started code execution.

8. After getting the memory semaphore (sem#1) indication from ALP 414A-414N, the BSLP 412 continues with its normal pre-boot tasks (for example: copying of code to memory, installing the runtime code in memory below 1 Meg).

9. Meanwhile step#10 to step#18 are executed by the ALP 414A-414N while the BSLP 412 is executing its own pre-boot tasks.

10. ALP 414A-414N initializes the register “ECX” to account for the entire memory from 2 Meg to Top of Memory (TOM) in increments of 128 bits (16 bytes).

11. ALP 414A-414N initialize the register “EDI” and “DS” to point to the starting memory location at 2 Meg.

12. ALP 414A-414N initializes the XMM register “xmm1”. This can be done by using the “MOVD” instruction. For example, Movd xmm[0], EAX (EAX is initialized to zeros before this instruction). This ends up loading a value of “0h” into the 128 bit register.

13. ALP 414A-414N initializes the XMM register “xmm2”. This can be done by using the “MOVDQA” instruction. For example, Movdqa xmm[1],dword ptr es:[esi] (ESI and ES are pointing to a 128 bit location in memory, in case there is no memory present this points to a location in the FWH-EEPROM). Bit#7 in each of the 16 bytes is set to a “1” indicating that each corresponding byte from xmm1 has to be written to memory.

14. The most significant bit of each byte in xmm2 indicates whether that corresponding byte from xmm1 is written to memory. A value of “1” indicates that the byte from source operand is written to memory and a value of “0” indicates that the byte from source operand is not written to memory.

15. ALP 414A-414N executes the “MASKMOVDQU xmm1, xmm2” instruction which stores selected bytes from first operand (xmm1) which is the source operand into an 128-bit memory location, the second operand (xmm2), the mask operand decides which bytes from source operand are written to memory. The source and mask operands are XMM registers.

16. ALP 414A-414N increments register “EDI” to advance by 128 bits (16 bytes) until the count in “ECX” goes to zero.

17. Execute step#15 and step#16 until the count goes to zero.

18. ALP 414A-414N indicates to the BSLP 412 using a memory semaphore (sem#2) that it has completed the task of ECC memory initialization.

As a result of the steps to initialize the entire memory to zeros, the new pre-boot software (System BIOS) 420 can perform ECC memory initialization operations faster on the Intel chipset based platforms thus giving an edge of faster and better performance.

PCI Bus Initialization:

8. After steps #1-#7, the BSLP 412 continues with its normal pre-boot tasks (for example: PIC, Timer, DMA, Programming User SETUP Options) after getting the memory semaphore (sem#1) indication from ALP 414A-414N.

9. Meanwhile, step#10 to step#13 are executed by the ALP 414A-414N while the BSLP 412 is executing its own pre-boot tasks.

10. ALP 414A-414N starts to find boot capable devices (Video capable devices with class code of 0300) and one or more PCI-to-PCI bridges (i.e., I/O controller hub “ICH” 150) present in the computer system 100.

11. ALP 414A-414N enumerates the PCI-to-PCI bridges (i.e., I/O controller hub “ICH” 150) present in the computer system 100 with appropriate PCI Bus#'s to accommodate for all PCI devices present behind the PCI-to-PCI bridges (i.e., I/O controller hub “ICH” 150) present in the computer system 100.

12. ALP 414A-414N assigns the resources to all PCI devices in the computer system 100, including (i) Assign I/O resources to all PCI devices requesting I/O in the computer system 100; (ii) Assign memory resources to all PCI devices requesting memory in the computer system 100; and (iii) Assign Interrupt resources to all PCI devices requesting an IRQ in the computer system 100.

13. ALP 414A-414N indicates to the BSLP 412 using a memory semaphore (sem#2) that it has completed the task of PCI Bus initialization.

As a result of the above steps to initialize the PCI devices in the computer system 100, the new pre-boot software (System BIOS) 420 can perform PCI Bus related initialization operations faster on the Intel chipset based platforms thus giving an edge of faster and better performance. Both the steps for ECC memory initialization and PCI bus initialization may be integrated concurrently and seamlessly during the boot-up process of the system BIOS 420 stored in the flash memory 160.

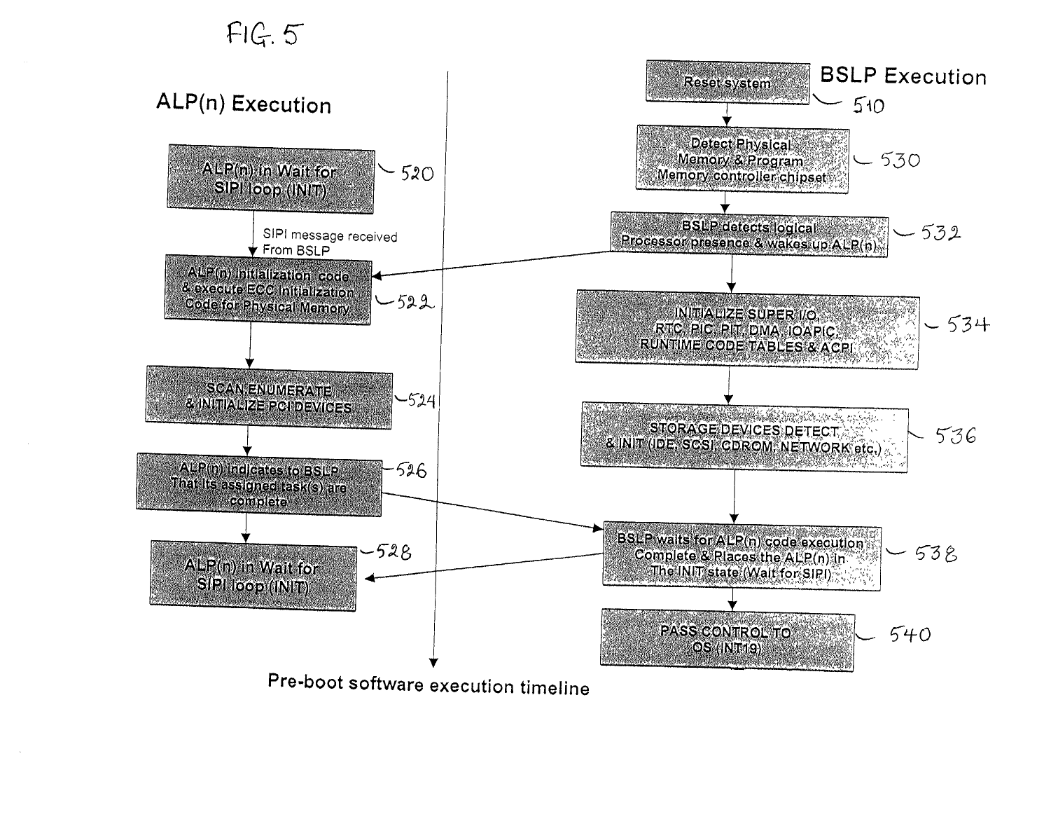

FIG. 5 illustrates an example boot-up process of a system BIOS 420 in conjunction with the computer system 100 having a single processor 410 equipped with Jackson Technology (JT) to serve as multiple logical processors (BSLP 412 and one or more ALP 414A-414N) according to an embodiment of the present invention. The boot-up process of the system BIOS 420 involves all necessary pre-boot tasks, including ECC memory initialization and PCI bus initialization until the control is passed to the operating system (OS). The physical processor 410 is assigned with a single Boot-Strap Logical Processor “BSLP” 412 and one or more Alternate Logical Processors (Application Processors) 414B-414N where N≧1 shown in FIG. 4. Therefore, multiple pre-book tasks (i.e., threads) such as ECC memory initialization and PCI bus initialization can be executed or performed simultaneously on a single physical processor 410 which appears as multiple logical processors, BSLP 412 and ALP 414A-414B. The BSLP execution thread (task) and the ALP(n) execution thread (task) will be described concurrently hereinbelow.

As shown in FIG. 5, following power-up or hard reset, the BSLP 412 begins the power-on self-test (POST) by executing the pre-boot software (system BIOS) 420 stored in the flash memory 160 at block 510. Initially, the ALP(n) 414A-414N remain waiting for the SIPI (Startup Inter-Processor Interrupt) from the BSLP 412 in order to be waken up at block 520.

Upon system reset, the BSLP 412 may detect physical memory (RAM) 132 and program memory controller hub (MCH) 120 at block 530. Then the BSLP 412 detects the presence of all logical processors—ALP(n) 414-414N, and wakes up the ALP(n) 414A-414N by sending the SIPI (Startup Inter-Processor Interrupt) to the ALP(n) 414A-414N at block 532.

When the ALP(n) 414A-414N is awaken upon receipt of the SIPI from the BSLP 412, the ALP(n) 414A-414N may retrieve ECC initialization code from the system BIOS 420 stored in the flash memory 160 and execute the pre-boot task of ECC memory initialization at block 522.

At the same time, the BSLP 412 may initialize the super I/O 170, all the internal hardware of the I/O controller hub (ICH) 150 such as the Real Time Clock (RTC) 152, the Programmable Interrupt Controller (PIC) 154, the Programmable Interval Timer (PIT) 156, the Direct Memory Access (DMA) 158, and the I/O Advanced Programmable Interrupt Controller (APIC) 159, the runtime code tables and the ACPI table at block 534. The BSLP 412 may then detect and initialize all storage devices (such as IDE hard disks, SCSI devices, CD-ROMs, NICs etc.) at block 536.

In the interim, the ALP(n) 414A-414N may proceed to accomplish the pre-boot task of PCI bus initialization at block 524. Again, PCI Bus initialization involves 1) scanning the PCI Bus 60 (find Boot capable devices, PCI-to-PCI bridges etc.); 2) enumerate the PCI bus 60 (find devices behind PCI-to-PCI bridges for eg: how many PCI buses are present); and 3) initialize all PCI devices connected to the PCI bus 60 (assign base addresses and enable decoding).

After the assigned tasks of ECC memory initialization and PCI bus initialization are completed at block 522 and block 524, respectively, the ALP(n) 414A-414N indicates to the BSLP 412 that its assigned tasks are completed at block 526.

In the meanwhile, the BSLP 412 waits for an indication from ALP(n) code execution completion, and upon receipt of such an indication, the BSLP 412 places the ALP(n) 414A-414N in the wait (INIT) state, waiting for the SIPI at block 538. The ALP(n) 414A-414N may, in turn, remain waiting for the SIPI loop (INIT) at block 528. The BSLP 412 then passes the control to the operating system (OS) at block 540.

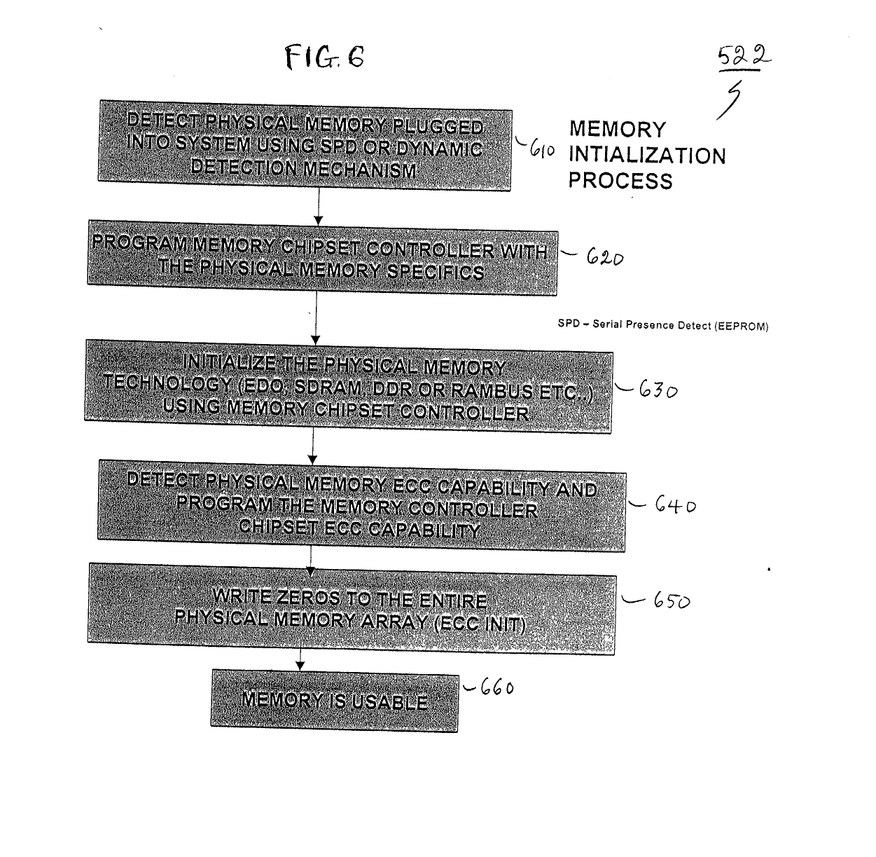

FIG. 6 illustrates an example ECC memory initialization process of the system BIOS 420 shown in FIG. 5. Upon receipt of the SIPI from the BSLP 412, the ALP(n) 414A-414N may begin to detect physical memory plugged into the computer system 100 using SPD (Serial Presence Detect) or Dynamic Detection Mechanism at block 610.

The ALP(n) 414A-414N may program the memory controller hub (MCH) 120 with the physical memory specifics at block 620, and then initialize the physical memory (which may include EDO, SDRAM, DDR or RAMBUS etc.) using the memory controller hub (MCH) 120 at block 630.

Next the ALP(n) 414A-414N may detect physical memory ECC (Error Checking and Correction) Capability and program the memory controller hub (MCH) 120 with ECC capability at block 640. Afterwards, the ALP(n) 414A-414N write zeros to the entire physical memory array at block 650 in order to ensure that the memory is usable at block 660.

As described in the foregoing, all pre-boot tasks including the ECC memory initialization and PCI bus initialization of the system BIOS 420 that is encoded in the flash memory 160 are executed in parallel by a single physical processor (CPU) 410 which appears as multiple logical processors (a single Boot-Strap Logical Processor “BSLP” 412 and one or more Alternate Logical Processors (Application Processors) 414B-414N where N≧1 shown in FIG. 4). As a result, the boot-up process of the system BIOS 420 can be executed much faster since multiple pre-boot tasks (threads) can be performed concurrently by multiple logical processors. Pre-boot software (system BIOS) 420 can be deployed to the computer system 100 manually or via networks such as the Internet. Such software programs may be a software module provided on a tangible medium, such as a floppy disk or compact disk ROM (CD-ROM), or via Internet downloads, which may be available for an IT administrator to conveniently plug-in or download into the host operating system (OS). Such software modules may also be available as a firmware module or a comprehensive hardware/software module which may be built-in the flash memory 160. In addition, method steps of FIGS. 5-6 may be performed by a computer processor executing instructions organized into a program module or a custom designed state machine. Storage devices suitable for tangibly embodying computer program instructions include all forms of non-volatile memory including, but not limited to: semiconductor memory devices such as EPROM, EEPROM, and flash devices; magnetic disks (fixed, floppy, and removable); other magnetic media such as tape; and optical media such as CD-ROM disks.

While there have been illustrated and described what are considered to be exemplary embodiments of the present invention, it will be understood by those skilled in the art and as technology develops that various changes and modifications may be made, and equivalents may be substituted for elements thereof without departing from the true scope of the present invention. For example, the computer system as shown in FIGS. 1 and 4 may be configured differently or employ some or different components than those illustrated. In addition, the boot-up process shown in FIGS. 5-6 may be configured differently or employ some or different components than those illustrated without changing the basic function of the invention. Further, the operating system (OS) may be designed to perform some of the same task as shown in FIGS. 5-6. Many modifications may be made to adapt the teachings of the present invention to a particular situation without departing from the scope thereof. Therefore, it is intended that the present invention not be limited to the various exemplary embodiments disclosed, but that the present invention includes all embodiments falling within the scope of the appended claims.

What is claimed is:

1. A computer system, comprising:
a processor equipped to serve as multiple logical processors;
a host chipset connected to the processor;
PCI devices connected to the host chipset, via a PCI bus; and
a main storage connected to the host chipset and arranged to store an operating system (OS) and contain a basic input/output system (system BIOS) configured to execute multiple pre-boot tasks, including memory initialization and PCI bus initialization concurrently, on the processor which serve as multiple logical processors before passing control to the operating system (OS).

2. The computer system as claimed in claim 1, wherein said main storage comprises:
a main memory arranged to store the operating system (OS) for use by the processor; and
a flash memory arranged to store the system BIOS and other applications that may execute during boot up (start-up) before the operating system (OS) is loaded.

3. The computer system as claimed in claim 1, wherein said processor equipped to serve as multiple logical processors allows the system BIOS to execute the memory initialization on one of the logical processors while enabling the other logical processor to proceed with PCI bus initialization tasks.

4. The computer system as claimed in claim 3, wherein said memory initialization is executed by:
detecting a physical memory array plugged into the computer system;
programming the host chipset with the physical memory specifics, and initializing the physical memory using the host chipset;
detecting a physical memory ECC (Error Checking and Correction) Capability; and
programming the host chipset with the ECC capability, and writing zeros to the entire physical memory array in order to ensure that memory is usable for the operating system (OS).

5. The computer system as claimed in claim 1, wherein said processor equipped to serve as multiple logical processors allows the system BIOS to execute the PCI bus initialization on one of the logical processors while enabling the other logical processor to proceed with other normal PCI device initialization tasks.

6. The computer system as claimed in claim 3, wherein said PCI bus initialization is executed by:
scanning all possible PCI buses connected to the host chipset;
after each PCI bus is scanned, scanning and initializing all possible PCI devices connected thereto on an individual basis;
after each PCI device is scanned, initializing all possible PCI functions assigned thereto on an individual function; and
terminating the PCI bus initialization, when all the PCI buses, all the PCI devices connected to each PCI bus, and all PCI functions assigned to each PCI device are scanned and initialized.

7. The computer system as claimed in claim 1, wherein said processor equipped to serve as multiple logical processors includes a Boot-Strap Logical Processor (BSLP) assigned to execute a set of pre-boot tasks and one or more Alternate Logical Processors (ALP) assigned to executed another set of pro-boot tasks concurrently until all assigned pre-boot tasks are completed before passing the control to the operating system (OS).

8. The computer system as claimed in claim 7, wherein, upon a system reset, said Boot-Strap Logical Processor (BSLP) executes the following pre-boot tasks:
detecting a physical memory, and programming the host chipset;
detecting the presence of all logical processors and sending a SIPI (Startup Inter-Processor Interrupt) to wake up the Alternate Logical Processor (ALP);
initializing all internal hardware of the host chipset, and all storage devices connected to the host chipset; and
waiting for ALP code execution completion to place the Alternate Logical Processor (ALP) in a wait state before passing the control to the operating system (OS).

9. The computer system as claimed in claim 8, wherein, upon receipt of the SIPI, said Alternate Logical Processor (ALP) executes the memory initialization and the PCI bus initialization respectively, while the Boot-Strap Logical Processor (BSLP) initializes all internal hardware of the host chipset and all storage devices connected to the host chipset, and after the memory initialization and PCI bus initialization are completed, indicates to the Boot-Strap Logical Processor (BSLP) that the memory initialization and PCI bus initialization are completed after all internal hardware of the host chipset and all storage devices connected to the host chipset are initialized by the Boot-Strap Logical Processor (BSLP).

10. The computer system as claimed in claim 9, wherein said memory initialization is executed by:
detecting a physical memory array plugged into the computer system;
programming the host chipset with the physical memory specifics, and initializing the physical memory using the host chipset;
detecting a physical memory ECC (Error Checking and Correction) Capability; and
programming the host chipset with the ECC capability, and writing zeros to the entire physical memory array in order to ensure that memory is usable for the operating system (OS).

11. The computer system as claimed in claim 9, wherein said PCI bus initialization is executed by:
scanning all possible PCI buses connected to the host chipset;
after each PCI bus is scanned, scanning and initializing all possible PCI devices connected thereto on an individual basis;
after each PCI device is scanned, initializing all possible PCI functions assigned thereto on an individual function; and
terminating the PCI bus initialization, when all the PCI buses, all the PCI devices connected to each PCI bus, and all PCI functions assigned to each PCI device are scanned and initialized.

12. A computer system, comprising:
a processor equipped to serve as multiple logical processors;
a host chipset connected to the processor;
PCI devices connected to the host chipset, via a PCI bus;
a main memory arranged to store the operating system (OS) for use by the processor; and
a flash memory arranged to store a basic input/output system (system BIOS) and other applications that may execute during boot up (start-up) before the operating system (OS) is loaded, wherein said system BIOS is configured to execute two different coordinate pre-boot tasks, including memory initialization and PCI bus initialization concurrently, on the processor which serve as multiple logical processors before passing control to the operating system (OS).

13. The computer system as claimed in claim 12, wherein said processor equipped to serve as multiple logical processors allows the system BIOS to execute the memory initialization on one of the logical processors while enabling the other logical processor to proceed with PCI bus initialization tasks.

14. The computer system as claimed in claim 13, wherein said memory initialization is executed by:
detecting a physical memory array plugged into the computer system;
programming the host chipset with the physical memory specifics, and initializing the physical memory using the host chipset;
detecting a physical memory ECC (Error Checking and Correction) Capability; and
programming the host chipset with the ECC capability, and writing zeros to the entire physical memory array in order to ensure that memory is usable for the operating system (OS).

15. The computer system as claimed in claim 12, wherein said processor equipped to serve as multiple logical processors allows the system BIOS to execute the PCI bus initialization on one of the logical processors while enabling the other logical processor to proceed with other normal PCI device initialization tasks.

16. The computer system as claimed in claim 15, wherein said PCI bus initialization is executed by:
scanning all possible PCI buses connected to the host chipset;
after each PCI bus is scanned, scanning and initializing all possible PCI devices connected thereto on an individual basis;
after each PCI device is scanned, initializing all possible PCI functions assigned thereto on an individual function; and
terminating the PCI bus initialization, when all the PCI buses, all the PCI devices connected to each PCI bus, and all PCI functions assigned to each PCI device are scanned and initialized.

17. The computer system as claimed in claim 12, wherein said processor equipped to serve as multiple logical processors includes a Boot-Strap Logical Processor (BSLP) assigned to execute a set of pre-boot tasks and one or more Alternate Logical Processors (ALP) assigned to executed another set of pro-boot tasks concurrently until all assigned pre-boot tasks are completed before passing the control to the operating system (OS).

18. The computer system as claimed in claim 17, wherein, upon a system reset, said Boot-Strap Logical Processor (BSLP) executes the following pre-boot tasks:
detecting a physical memory, and programming the host chipset;
detecting the presence of all logical processors and sending a SIPI (Startup Inter-Processor Interrupt) to wake up the Alternate Logical Processor (ALP);
initializing all internal hardware of the host chipset, and all storage devices connected to the host chipset; and
waiting for ALP code execution completion to place the Alternate Logical Processor (ALP) in a wait state before passing the control to the operating system (OS).

19. The computer system as claimed in claim 18, wherein, upon receipt of the SIPI, said Alternate Logical Processor (ALP) executes the memory initialization and the PCI bus initialization respectively, while the Boot-Strap Logical Processor (BSLP) initializes all internal hardware of the host chipset and all storage devices connected to the host chipset, and after the memory initialization and PCI bus initialization are completed, indicates to the Boot-Strap Logical Processor (BSLP) that the memory initialization and PCI bus initialization are completed after all internal hardware of the host chipset and all storage devices connected to the host chipset are initialized by the Boot-Strap Logical Processor (BSLP).

20. The computer system as claimed in claim 19, wherein said memory initialization is executed by:
detecting a physical memory array plugged into the computer system;
programming the host chipset with the physical memory specifics, and initializing the physical memory using the host chipset;
detecting a physical memory ECC (Error Checking and Correction) Capability; and
programming the host chipset with the ECC capability, and writing zeros to the entire physical memory array in order to ensure that memory is usable for the operating system (OS).

21. The computer system as claimed in claim 19, wherein said PCI bus initialization is executed by:
scanning all possible PCI buses connected to the host chipset;
after each PCI bus is scanned, scanning and initializing all possible PCI devices connected thereto on an individual basis;
after each PCI device is scanned, initializing all possible PCI functions assigned thereto on an individual function; and
terminating the PCI bus initialization, when all the PCI buses, all the PCI devices connected to each PCI bus, and all PCI functions assigned to each PCI device are scanned and initialized.

22. A computer readable medium having stored thereon a set of system basic input/output start-up “system BIOS” instructions configured a single physical processor equipped to serve as a Boot-Strap Logical Processor (BSLP) and an Alternate Logical Processor (ALP) which, when executed by a processor during start-up, cause the Boot-Strap Logical Processor (BSLP) and the Alternate Logical Processor (ALP) to perform:
detecting, at the Boot-Strap Logical Processor (BSLP), detecting a physical memory, programming the host chipset, detecting the presence of all logical processors and sending a SIPI (Startup Inter-Processor Interrupt) to wake up the Alternate Logical Processor (ALP);
initializing, at the Boot-Strap Logical Processor (BSLP), all internal hardware of the host chipset, all storage devices connected to the host chipset, and waiting for ALP code execution completion to place the Alternate Logical Processor (ALP) in a wait state before passing the control to the operating system (OS); and
executing, at the Alternate Logical Processor (ALP), memory initialization and PCI bus initialization respectively, while the Boot-Strap Logical Processor (BSLP) initializes all internal hardware of the host chipset and all storage devices connected to the host chipset, and after the memory initialization and PCI bus initialization are completed, indicates to the Boot-Strap Logical Processor (BSLP) that the memory initialization and PCI bus initialization are completed after all internal hardware of the host chipset and all storage devices connected to the host chipset are initialized by the Boot-Strap Logical Processor (BSLP).

23. The computer readable medium as claimed in claim 22, wherein said memory initialization is executed by the Alternate Logical Processor (ALP) by:
detecting a physical memory array plugged into the computer system;
programming the host chipset with the physical memory specifics, and initializing the physical memory using the host chipset;
detecting a physical memory ECC (Error Checking and Correction) Capability; and
programming the host chipset with the FCC capability, and writing zeros to the entire physical memory array in order to ensure that memory is usable for the operating system (OS).

24. The computer readable medium as claimed in claim 22, wherein said PCI bus initialization is executed by the Alternate Logical Processor (ALP) by:
scanning all possible PCI buses connected to the host chipset;
after each PCI bus is scanned, scanning and initializing all possible PCI devices connected thereto on an individual basis;
after each PCI device is scanned, initializing all possible PCI functions assigned thereto on an individual function; and
terminating the PCI bus initialization, when all the PCI buses, all the PCI devices connected to each PCI bus, and all PCI functions assigned to each PCI device are scanned and initialized.
